(19) United States
(12) Patent Application Publication
(10) Pub. No.: US 2024/0367091 A1
(43) Pub. Date: Nov. 7, 2024

(54) Processes For Suppressing Emission of Mercury Vapor

(71) Applicant: Albemarle Corporation, Charlotte, NC (US)

(72) Inventors: Kim Sehye Pingree, Baton Rouge, LA (US); Jon Miller, Baton Rouge, LA (US); Zhongxin Ge, Baton Rouge, LA (US); Zhaorong Zhang, Baton Rouge, LA (US); Sascha Welz, Phoenix, AZ (US)

(21) Appl. No.: 18/580,424

(22) PCT Filed: Jul. 12, 2022
(86) PCT No.: PCT/US2022/036865

§ 371 Date: Jan. 18, 2024

Related U.S. Application Data
(60) Provisional application No. 63/227,645, filed on Jul. 30, 2021.

(51) Int. Cl. B01D 53/12; B01D 53/00; B01J 20/20

(52) U.S. Cl. CPC B01D 53/12; B01D 53/005; B01J 20/20; B01D 2253/102; B01D 2253/25; B01D 2257/602

(57) ABSTRACT

This invention provides processes for suppressing emission of mercury vapor from substances containing vaporizable mercury.

### TECHNICAL FIELD

This invention relates to suppression of mercury vapor emission using sorbents.

### BACKGROUND

Many pollutants are known be toxic to humans and to the environment. One of these known environmental pollutants, mercury, has been categorized as a priority hazardous substance by the Agency for Toxic Substances and Disease Registry (ATSDR) of the U.S. Health and Human Services Department.

Mercury species, especially elemental mercury, volatilizes from various contaminated materials such as mining waste, metal working waste, soil, building materials, interior contaminated surfaces, and biomass waste. When contaminated materials or surfaces are disturbed, mercury is vaporized from the contaminated materials or surfaces, which increases the level of mercury in air, often exceeding the standards for safe working environments set by the U.S. Occupational Safety and Health Organization (OSHA). At ambient conditions, the evaporation rate for elemental mercury from substances is limited by temperature and air volume equalization parameters, so the vaporized amount of mercury at ambient conditions is typically only a small percentage of the available vaporizable mercury.

For decontamination, demolition, and decommissioning activities where mercury contamination exists in the buildings and/or in the site soil, these activities can cause indoor mercury vapor concentrations to exceed the permissible exposure limit (PEL) of 0.1 milligrams per cubic meter of air (mg/m³) set by OSHA, which limit is currently enforced as an 8-hour time-weighted average. Additionally, these activities in populated areas are often constrained by air permits, which require meeting a mercury concentration limit in air measured outside the fence line of the activity site. These problems can make such activities costly to permit and to conduct without a means to suppress the mercury vaporization during the activities.

During the redevelopment of some industrial sites, a concentration of elemental mercury in soil below the regulatory action level can cause unsafe levels of mercury vapor intrusion into new structures built on the site. Therefore, when vaporizable mercury exists in the soil, expensive systems may be necessary to stop mercury vapor from entering buildings on such sites.

In some instances, the entire material may be classified as hazardous because it cannot pass the TCLP or SPLP leaching tests for mercury. The U.S. EPA regulates this as well, and uses the Toxicity Characteristic Leaching Procedure (TCLP), a test designed to determine the mobility of analytes such as mercury, and the Synthetic Precipitation Leaching Procedure (SPLP) to determine the amount of mercury that is migrating. The soil around and under the building may also be classified as hazardous due to Hg contamination. Disposal of waste materials and soil classified as hazardous is expensive and may prevent the desired activities at the site.

Suppressing mercury vapor emission from substances at some sites can be technically challenging, depending on the substance that contains vaporizable mercury, the condition of the substance, and mercury forms present.

Another factor also determined by the TCLP or SPLP leaching tests for some mercury treatments is the tendency for mercury to migrate from (or leach out of) the treatment medium.

Complicated bench- and pilot-scale research and screening tests have to be conducted to evaluate a technology to determine if it is suitable before it is selected to suppress mercury vapor emission from an actual substance containing vaporizable mercury. In addition, the variability with each substance to be treated can make the suppression of mercury vapor expensive and time-consuming. Thus, there is a need for new and more commercially attractive processes for suppressing mercury vapor from substances containing vaporizable mercury.

### SUMMARY OF THE INVENTION

This invention provides processes for suppressing mercury vapor emission. A benefit provided by the processes of this invention is suppression of mercury vapor emission from substances containing vaporizable mercury.

Another advantage of the processes of the invention is that acidic conditions do not negatively affect suppression of mercury vapor emission. Still another advantage of the processes of this invention is that the mercury is not leachable from the sorbent.

Halogen-containing sorbents, especially halogen-containing activated carbons, more especially bromine-containing activated carbons, when added to, spread over, or sprayed onto substances containing vaporizable mercury or surfaces thereof to create protective barriers, will adsorb volatilizing mercury and/or pre-volatilized mercury. Halogen-containing sorbents used in this invention not only provide protective barriers that suppress mercury vapor emissions to meet OSHA requirements, but also reduce the leachability of mercury from the treated materials, which allows the material to be disposed of by less expensive means.

Mercury captured by the halogen-containing sorbents used in the practice of this invention is generally non-leachable as determined by either the TCLP or SPLP method.

Processes of this invention can be used as the sole process for suppressing mercury vapor emission, or the processes of this invention can be used to complement and/or enhance the suppression of mercury vapor emission attained by existing technologies.

An embodiment of this invention is a process for suppressing mercury vapor emission from a substance comprising vaporizable mercury. The process comprises applying a halogen-containing sorbent to a substance containing vaporizable mercury, and allowing perturbation of the substance to cause mercury to volatilize. Applying the halogen-containing sorbent to the substance suppresses emission of at least a portion of mercury vapor from the substance.

These and other embodiments and features of this invention will be still further apparent from the ensuing description and appended claims.

### BRIEF DESCRIPTION OF THE DRAWINGS

FIG. 1 is a graph showing the amount of mercury passing through a mixture of plain powdered activated carbon and sand over time in comparative Example 1.

FIG. 2 is a graph showing the amount of mercury passing through a mixture of brominated powdered activated carbon and sand over time in Example 2.

FIG. 3 is a graph showing the amount of nonleachable mercury measured in Example 4.

The figures illustrate embodiments of specific aspects of the invention, and are not intended to impose limitations on the scope of the invention.

### FURTHER DETAILED DESCRIPTION OF THE INVENTION

Suppression of mercury vapor emission refers to reduction of the amount of mercury vapor, by capturing the mercury before, during, or after vaporization of the mercury from the substance.

Throughout this document, the term “capturing” refers to stabilizing, immobilizing, fixing, encapsulating, isolating, containing, destroying, detoxifying, decomposing, and decaying, reducing the amount of, reducing the mobility of, and/or reducing the migration ability of, mercury.

As used throughout this document, terms such as “treated”, “contacted”, and “remediated” indicate that the halogen-containing sorbent interacts with the substance containing vaporizable mercury in a manner that results in the suppression of mercury vapor emission.

Mercury vapor emission suppression agents in the practice of this invention are halogen-containing sorbents, sometimes referred to herein as “halogenated sorbents”. Halogen-containing sorbents are typically formed from one or more halogen-containing compounds, and one or more substrate materials. Many substrate materials, especially activated carbons, are available or obtainable in a wide range of particle sizes, from nanometer to centimeter.

Substrate materials include carbonaceous materials and inorganic materials. Suitable carbonaceous materials include, for example, without limitation, activated carbon, carbon black, char, and coke. A preferred carbonaceous material is activated carbon, which can be used in many forms including, for example, without limitation, powdered, granular, or extruded; and high specific surface area. Powdered activated carbon is a particularly preferred form of activated carbon.

Suitable inorganic materials include inorganic oxides such as alumina (amorphous and crystalline), silica, magnesia and titania: natural zeolites, such as chabazite, clinoptilolite, and faujasite; synthetic zeolites, such as synthetic chabazite, A zeolites, sodalite, zeolites with high Si:Al ratios (ZSM-5, beta zeolites), zeolites with moderate Si:Al ratios (Y zeolites), silica alumina phosphate (SAPO) zeolites, ion exchanged zeolites, uncalcined zeolites, clay minerals such as kaolin, kaolinite, bentonite, and montmorillonite; inorganic hydroxides such as iron hydroxide; mixed metal oxides such as hydrotalcites and metallated double layered clays; diatomaceous earth; cement dust; hydroprocessing catalysts including those on substrates such as alumina, silica, or titania; CaCO₃; and combinations of any two or more of the foregoing. Preferred inorganic materials include inorganic oxides, especially silica, natural zeolites, especially chabazite, and clay minerals, especially kaolinite and bentonite; CaCO₃ is also a preferred substrate material.

The halogen element in the halogen-containing sorbent can be chlorine, bromine, iodine, or a mixture of any two or more of these halogens. Bromine and iodine are preferred halogens; bromine is a more preferred halogen. Suitable halogen-containing compounds include, for example, without limitation, elemental iodine and/or iodine compounds, elemental bromine and/or bromine compounds, elemental chlorine and/or chlorine compounds. Iodine-containing and bromine-containing compounds are preferred halogen-containing compounds; bromine-containing compounds are more preferred.

Types of halogen-containing compounds that can be used include hydrohalic acids, alkali metal halides, alkaline earth halides, and ammonium halides. Hydrohalic acids include hydrogen chloride, hydrogen bromide, and hydrogen iodide. Alkali metal halides include sodium chloride, sodium bromide, sodium iodide, potassium chloride, potassium bromide, and potassium iodide. Alkaline earth halides include magnesium chloride, magnesium bromide, calcium chloride, and calcium bromide. Ammonium halides include ammonium chloride, ammonium bromide, and ammonium iodide. Preferred halogen-containing compounds include elemental bromine, hydrogen bromide, sodium chloride, sodium bromide, potassium iodide, and calcium bromide. More preferred are hydrogen bromide and elemental bromine, especially elemental bromine.

Halogen-containing sorbents can be made from the substrate material and halogen-containing compounds, especially for bromine-containing sorbents, as described in U.S. Pat. Nos. 6,953,494 and 9,101,907, and in International Patent Pub. No. WO 2012/071206. In some embodiments, preferred halogen-containing sorbents are bromine-containing sorbents. In some embodiments, preferred halogen-containing sorbents are halogen-containing activated carbons. In other embodiments, preferred halogen-containing activated carbons are chlorine-containing activated carbons, bromine-containing activated carbons, and iodine-containing activated carbons. In preferred embodiments, the halogen-containing sorbents are iodine-containing activated carbons and bromine-containing activated carbons. In more preferred embodiments, the halogen-containing sorbents are bromine-containing activated carbons. Bromine-containing activated carbons are available commercially from Albemarle Corporation.

In other embodiments, preferred halogen-containing sorbents are halogen-containing chabazites, halogen-containing bentonite, halogen-containing kaolinites, and halogen-containing silicas: more preferred halogen-containing sorbents are iodine-containing chabazites, bromine-containing chabazites, iodine-containing bentonite, bromine-containing bentonite, iodine-containing kaolinites, bromine-containing kaolinites, iodine-containing silicas, and bromine-containing silicas: still more preferred are bromine-containing silica, bromine-containing kaolinite, and bromine-containing bentonite.

The amount of halogen (or halogen content) on the substrate material is typically equivalent to a total bromine content (or calculated as bromine) in the range of about 0.1 wt % to about 30 wt %, preferably equivalent to a total bromine content in the range of about 0.1 wt % to about 25 wt %, more preferably about 0.1 wt % to about 20 wt %, even more preferably about 0.5 wt % to about 15 wt %, still more preferably about 2 wt % to about 12 wt %, and yet more preferably about 3 wt % to about 8 wt %, based on the total weight of the halogen-containing sorbent.

As used throughout this document, the phrases “as bromine,” “reported as bromine.” “calculated as bromine,” and analogous phrases for the halogens refer to the amount of halogen, where the numerical value is calculated for bromine, unless otherwise noted. For example, elemental fluorine may be used, but the amount of halogen in the halogen-containing sorbent is stated as the value for bromine.

Halogen-containing activated carbons suitable for use in processes of this invention can have a wide range of particle sizes and distributions, from nanometer to centimeter; and can be formed from activated carbon forms including, for example, without limitation, powdered, granular, or extruded: high specific surface area, a variety of unique pore structures; and other features as will be familiar to those skilled in the art.

Halogen-containing sorbents, especially halogen-containing carbonaceous sorbents, especially iodine-containing and bromine-containing sorbents, more especially bromine-containing carbonaceous sorbents, can suppress mercury vapor emission from substances through means including, for example, without limitation, oxidation and/or adsorption. Adsorption can reduce the emission of mercury vapor by reducing mobility of mercury. In the processes of this invention, the mercury adsorbed by halogen-containing sorbents is stabilized such that desorption (and re-emission) is substantially minimized.

Mercury is adsorbed onto halogen-containing sorbents, especially halogen-containing activated carbons, more especially iodine-containing and bromine-containing sorbents, still more especially bromine-containing carbonaceous sorbents. Different bromine species can be formed on halogen-containing sorbents, especially halogen-containing activated carbon. For example, bromine, a bromine species, can oxidize elemental mercury and form mercuric bromide which can be adsorbed into pores of activated carbon; another species, bromide ion, can chemically bond with ionic mercury for adsorption onto the surface of activated carbon; another component might catalyze mercury oxidation and enhance the stabilization or adsorption of the oxidized mercury product in the sorbent.

Some halogen-containing sorbents, particularly halogen-containing activated carbons, especially iodine-containing and bromine-containing sorbents, more especially bromine-containing carbonaceous sorbents, can physically and chemically adsorb mercury of different oxidation states including elemental mercury, oxidized mercury, and organic mercury. Mercury adsorbed on halogen-containing activated carbon, especially bromine-containing activated carbon, is stable in a wide range of pH values, where “stable” means that the mercury does not separate from the sorbent in appreciable amounts after adsorption.

Sorbents used in processes of this invention can be combined with other optional components such as pH buffers (including, for example, without limitation, carbonates and phosphates); carriers (including, for example, without limitation, sand and mud); binders (including, for example, without limitation, mud, clay, and polymers); and/or other additives (including, for example, without limitation, iron compounds and sulfur compounds).

In the practice of this invention, the halogen-containing sorbent can be used in various forms, including as a dry sorbent alone or in admixture with another dry solid, such as sand, or in combination with a suitable fluid, for example, in a suspension or a slurry. As used herein, the term “suitable fluid” means fluids such as water and other fluids; preferably, the fluid is water. In some embodiments, a slurry of the halogen-containing sorbent in water, which can be sprayed onto the substance containing vaporizable mercury, is preferred. When used in a slurry or suspension, the halogen-containing sorbent is about 0.1 wt % to about 45 wt %, preferably about 5 wt % to about 40 wt %, of the slurry or suspension; above 45 wt % halogen-containing sorbent, a paste is formed. When used as a dry solid, the halogen-containing sorbent can be used alone or in admixture with at least one additional dry ingredient.

In some applications, the halogen-containing sorbent will remain in or with the substance. In other applications, the halogen-containing sorbent may be collected after use. When the halogen-containing sorbent is collected after use, the sorbent can be disposed of, or regenerated and re-used.

The halogen-containing sorbent can be used as a stand-alone treatment or can complement other treatment methods. In other processes according to the invention, the halogen-containing sorbent can be used in addition to one or more other mercury-treating agents in the same treatment procedure.

When a halogen-containing sorbent is added to a substance containing vaporizable mercury, the halogen-containing sorbent may adsorb mercury before, during, and/or after vaporization. In some embodiments, the halogen-containing sorbent remains with or in the substance. In other embodiments, the combined halogen-containing sorbent and substance are placed in landfill, often with a binder and other compounds.

Processes of the invention are provided for suppressing emission of at least a portion of mercury vapor in a substance comprising vaporizable mercury.

The substances treated in the practice of this invention are typically solids. In some embodiments, the surface of the substance, instead of or in addition to the bulk substance, is treated with the halogen-containing sorbent. In other embodiments, the substance is treated by introducing the halogen-containing sorbent subsurface to the substance. As used herein, the term “substance” and/or “substances”, include without limitation, walls, floors, ceilings, equipment, building materials, soil, debris, waste material, mining byproducts, fly ash, cement, and other such substances. Waste materials include mining waste, metal working waste, and biomass waste. Preferred substances to treat in the practice of this invention include soil, waste material, especially mining waste, mining byproducts, fly ash, and building materials.

The applying of the halogen-containing sorbent to the substance can comprise:
(a) applying the halogen-containing sorbent to a surface of the substance; and/or
(b) combining the halogen-containing sorbent with at least a portion of a surface of the substance; and/or
(c) adding the halogen-containing sorbent to a reactive barrier; and/or
(d) forming a reactive barrier containing the halogen-containing sorbent; and/or
(e) introducing the halogen-containing sorbent subsurface to the substance.

Combining the halogen-containing sorbent with a surface of the substance as in (b) above can be done by combining the halogen-containing sorbent with a portion of the substance, and then applying the combination of sorbent and substance portion to the surface of the substance, or by combining the halogen-containing sorbent with the surface of the substance.

Some preferred methods for applying the halogen-containing sorbent to the solid are:
(a) applying a halogen-containing sorbent to a surface of the substance; and/or
(b) combining a halogen-containing sorbent with at least a portion of a surface of the substance.

Halogen-containing sorbents can be added to, spread over, or sprayed as an aqueous suspension or slurry onto the mercury-containing substances and surfaces thereof to suppress mercury vapor emission.

A preferred method of applying the halogen-containing sorbents is spraying a suspension or slurry of the halogen-containing sorbent, especially to coat or partially coat a surface of the substance, or spreading a dry solid comprising the halogen-containing sorbent onto the surface of a substance.

In another embodiment of this invention in which halogen-containing sorbents, especially halogen-containing activated carbons, are treatment agents for mercury contaminated soil, the halogen-containing sorbent is preferably spread on top of the soil. In this method, the halogen-containing sorbent, especially a halogen-containing activated carbon, is present in the top layer of soil and suppresses mercury vapor emission by blocking migration of mercury from the soil. Subsurface treatment is another preferred method for treating soil.

Halogen-containing sorbents, especially iodine-containing or bromine-containing sorbents, more especially bromine-containing activated carbons, can be mixed with another agent to create a mixture that improves penetration of the halogen-containing sorbent into the substance, especially soil. The amount of halogen-containing sorbent added may be less than 10% of the top layer of soil, and the top layer of soil may be up to 10 cm thick. In some embodiments, a pH adjustment agent is also applied, either separately or in admixture with the halogen-containing sorbent, optionally along with an agent that improves penetration of the halogen-containing sorbent into the substance.

Perturbations can be man-made or naturally-occurring, and include any suitable perturbation (disturbance) of the substance that causes at least a portion of the vaporizable mercury to vaporize from the substance. Typical perturbations include heating (especially to cause desorption from soil), vibrations, light waves, sound waves, movement of at least a portion of the substance, and enclosing at least a portion of the substance. Enclosing a substance or a portion of a substance is considered a perturbation. For example, enclosure can cause the concentration of mercury vapor in the enclosed space above the substance to increase because mercury vapor being released from the substance is not dissipating, and/or the surface of the enclosed substance heats up, which in turn increases the concentration of mercury vapor in the enclosed space above the substance. Heating is a preferred perturbation. Another preferred perturbation is enclosing at least a portion of the substance. As the substance is perturbed, the brominated sorbent can absorb the mercury. The substances treated in this invention typically do not release mercury spontaneously in the absence of a perturbation of the substance.

Allowing perturbation of a substance causes mercury to volatilize from the substance. In some instances, applying a perturbation may not be necessary, for example due to naturally-occurring perturbations. In some embodiments, due to naturally-occurring perturbations, mercury releases over time, and the halogen-containing sorbent captures mercury as the mercury vaporizes from the substance. In some embodiments, a manmade perturbation is applied to the substance.

Heating of the substance to which the halogen-containing sorbent has been added and/or applied typically induces desorption of mercury. Naturally-occurring forms of heating include solar heating: solar heating is a preferred perturbation. Manmade methods of heat-caused desorption include thermal desorption, which usually involves covering an area to be heated and removing the vapor under the covered area at least during heating. The halogen-containing sorbent can suppress mercury vapor emission by capturing the mercury as it exits the substance being heated.

In heating perturbations in the practice of this invention, the temperature is usually about ambient temperature (about 25° C.) to about 45° C., which is generally sufficient to volatilize mercury from the substance. A gas flow is not usually applied for solar heating. Mercury emission control in flue gases is typically conducted at much higher temperatures (150° C. to 300° C.), usually with high gas flow rates.

Mercury adsorbed by halogen-containing powdered activated carbon is stable during making and curing of concrete: see for example U.S. Pat. Nos. 8,404,038 and 8,420,033. This is advantageous when treating fly ash and cement, and substances that contain fly ash and/or cement.

In some embodiments, the halogen-containing sorbent is used in decontamination, demolition, and decommissioning activities: the halogen-containing sorbent is applied inside and/or outside e.g., a building before and/or during demolition to suppress mercury vapors and allow all of the waste materials to be classified as nonhazardous. This will reduce costs for decontamination, demolition, and decommissioning activities, be safer for workers, and in some instances permit decontamination, demolition, and decommissioning activities at contaminated sites at which these activities previously could not be conducted.

In other embodiments, the halogen-containing sorbent is used in decontamination processes, often in working environments, by applying (preferably spraying) the halogen-containing sorbent onto walls, ceilings, and equipment. An example of a site to decontaminate is a carbon adsorption bed building in a non-ferrous metals processing plant.

In still other embodiments, the halogen-containing sorbent is sprayed as a suspension or slurry onto soil that is being worked under an enclosure (e.g., a tent), to suppress mercury vapor emission from the soil so that the mercury concentration inside the enclosure remains below safe working concentrations (set by OSHA). While the soil may not contain enough mercury to warrant specific remediation, the enclosure erected over the work area can concentrate mercury inside the enclosure.

In other embodiments, the halogen-containing sorbent can be added or applied to fly ash or other substances containing loosely bound mercury, and causing the loosely bound mercury in the fly ash or other substances to vaporize and be absorbed by the halogen-containing sorbent: preferably, the halogen-containing sorbent is mixed into or sprayed onto the fly ash or other substances.

The following examples are presented for purposes of illustration, and are not intended to impose limitations on the scope of this invention.

### EXAMPLES

### Experimental Setup and Procedure

Two glass columns having a height of 12 inches (30.5 cm) and a 2-inch (5.1 cm) diameter to be used as beds for the adsorption tests had approximately 1 inch (2.5 cm) of glass wool inserted at the bottom of each column. The moisture content of the sand was measured, and when the moisture content was above 3%, the sand was dried at a relatively low temperature (50° C.) in an oven. A volume of sand (26 mL; approximately 2 inches (5 cm) of height when packed in the column) was weighed for each column. For the mixtures, the desired amount of powdered activated carbon (PAC) or brominated powdered activated carbon (Br-PAC) was weighed relative to the amount of dry sand and mixed with the dry sand to homogenize the mixtures. Enough water to increase the moisture content to about 8 wt % was then added to the mixtures, and to the sand-only samples. Each column was loaded with sand or a sand mixture on top of the glass wool to form beds, and then the columns were sealed. The sealed columns were mounted on stands in an oven, and tubing was connected to the columns.

A mercury generator to provide elemental mercury vapor was connected to diffusion tubes in an oil bath. A bypass line for the mercury vapor around the columns was set up to permit troubleshooting and as an additional control stream.

The valve (perfluoroalkoxy (PFA): Swagelok Company) settings were adjusted to bypass the mercury generator and the columns. The compressed air stream was turned on, and the air stream flow rate was adjusted to about 5 L/min with the regulator and the rotameter's needle valve as needed. The oil containing the mercury generator was heated to a temperature (70° C.) that produced the desired concentration of mercury vapor (about 50 μg/m³) in the air stream that passed over the diffusion tubes. The oven containing the columns was heated to 35° C., and kept at this temperature throughout the test period for the columns.

The valve settings were then adjusted to direct the air stream through the mercury generator but to bypass the columns. The sample valve was opened to the mercury vapor analyzer (atomic fluorescence spectroscopy, Jerome® J505) and analysis of the air stream began. The mercury generator temperature and/or air flow rate were adjusted as needed to achieve the desired mercury vapor concentration. When a stable mercury concentration was achieved in the air stream, the valves were set to direct the flow of mercury-containing air stream through the columns from the bottom of the columns and flowed up through the material in each column. The air stream leaving the top of each column was analyzed for the presence of mercury vapor.

After the tests were completed, the valves were adjusted to bypass the columns to measure the mercury vapor in the air stream, to verify that it agreed with the earlier-measured baseline concentration. Then each column was flushed with a separate stream of mercury-free air (bypassing the mercury generator). The air exiting the columns was analyzed to confirm that no mercury was being released from the columns. The columns were removed from the oven and the material in each column was poured into a separate glass sample jar; the glass wool was pushed out of the column to ensure collection of all of the material from the respective column in the sample jar. The material in each sample jar was analyzed for total mercury and for leachable mercury.

### Example 1-Comparative

In a first test, wet sand (8 wt % water) was added to a column and mercury vapor passed through the column to confirm that the sand did not adsorb a significant amount of mercury vapor. For a timed test run, clean, dry sand was mixed with powdered activated carbon (PAC; 1 wt %) and de-ionized (DI) water (8 wt %); the amounts are relative to the dry weight of the sand. The PAC/wet sand mixture was added to a column.

The mercury generator was started, and the gas bypassing the PAC/wet sand column was sampled once, and the gas exiting the PAC/wet sand column was sampled at various time intervals, and the amount of mercury in the gas samples was measured to determine the amount of mercury that passed through the column. Results are summarized in Table 1 and graphically in FIG. 1, which shows the amount of mercury passing through the powdered activated carbon/wet sand mixture over time. Sample 1 is from the gas bypassing the column, which contained the full amount of mercury vapor produced in the mercury generator (baseline); Samples 2-23 are from the column that contained the mixture of wet sand and 1 wt % powdered activated carbon. All runs are comparative.

TABLE 1

| Sample | Δt, hr:min | Hg in vapor, μg/m³ |
|---|---|---|
| 1 | 0:00 | 51.60 |
| 2 | 0:00 | 47.14 |
| 3 | 0:01 | 52.89 |
| 4 | 0:03 | 54.53 |
| 5 | 0:08 | 45.56 |
| 6 | 0:14 | 29.86 |
| 7 | 0:18 | 22.22 |
| 8 | 0:49 | 19.39 |
| 9 | 1:16 | 22.97 |
| 10 | 1:27 | 24.55 |
| 11 | 1:36 | 25.75 |
| 12 | 1:51 | 26.89 |
| 13 | 2:08 | 28.12 |
| 14 | 2:53 | 28.94 |
| 15 | 3:12 | 30.47 |
| 16 | 3:29 | 31.51 |
| 17 | 3:59 | 31.87 |
| 18 | 4:04 | 31.98 |
| 19 | 4:14 | 32.33 |
| 20 | 4:21 | 33.54 |
| 21 | 4:31 | 33.16 |
| 22 | 4:43 | 33.15 |
| 23 | 4:58 | 32.84 |

The data above demonstrate that the mixture of PAC and sand captures some of the mercury passing through the column, but a significant amount of mercury vapor passed through the PAC/sand mixture and was not captured. The data suggest that a significant amount of the PAC was saturated by mercury vapor about 50 minutes after the test began because the amount of mercury passing through the PAC/sand mixture increased after 50 minutes.

### Example 2

In a first test, wet sand (8 wt % water) was added to a column and mercury vapor passed through the column to confirm that the sand did not adsorb a significant amount of mercury vapor. For a timed test run, clean, dry sand was mixed with brominated powdered activated carbon (Br-PAC; 1 wt %) and de-ionized (DI) water (8 wt %); the amounts are relative to the dry weight of the sand. The Br-PAC/wet sand mixture was added to a column.

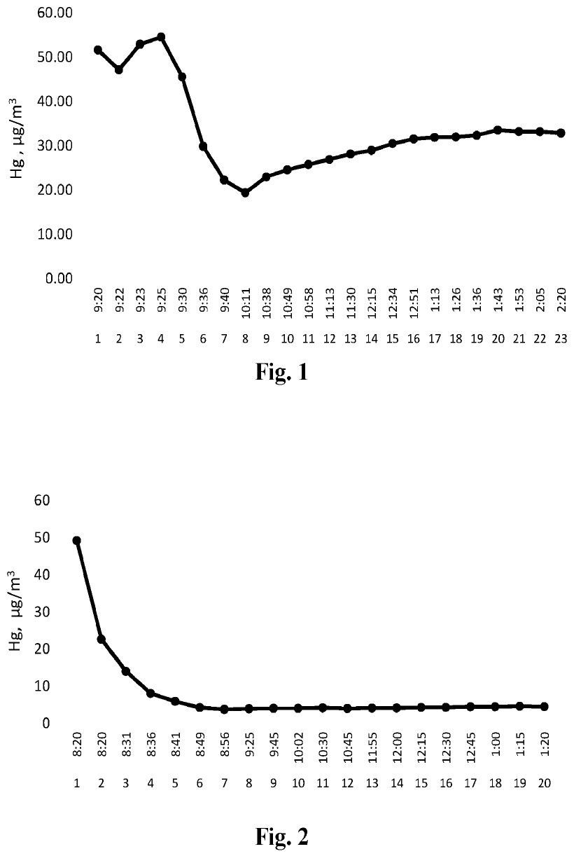

The mercury generator was started, and the gas bypassing the Br-PAC/wet sand column was sampled once, and the gas exiting the Br-PAC/wet sand column was sampled at various time intervals, and the amount of mercury in the gas samples was measured to determine the amount of mercury that passed through each column. Results are summarized in Table 2 and graphically in FIG. 2, which shows the amount of mercury passing through the Br-PAC/wet sand mixture over time. Sample 1 is from the gas bypassing the column, which contained the full amount of mercury vapor produced in the mercury generator (baseline), and is comparative. Samples 2-20 are from the column that contained the mixture of wet sand and 1 wt % Br-PAC. The Br-PAC had a bromine content of 8 wt %.

TABLE 2

| Sample | Δt, hr:min | Hg in vapor, μg/m³ |
|---|---|---|
| 1* | 0:00 | 49.17 |
| 2 | 0:00 | 22.56 |
| 3 | 0:11 | 13.93 |
| 4 | 0:16 | 8.00 |
| 5 | 0:21 | 5.85 |
| 6 | 0:29 | 4.17 |
| 7 | 0:36 | 3.70 |
| 8 | 1:05 | 3.87 |
| 9 | 1:25 | 3.98 |
| 10 | 1:42 | 3.98 |
| 11 | 2:10 | 4.10 |
| 12 | 2:25 | 3.94 |
| 13 | 3:35 | 4.06 |
| 14 | 3:40 | 4.07 |
| 15 | 3:55 | 4.19 |
| 16 | 4:10 | 4.23 |
| 17 | 4:25 | 4.40 |
| 18 | 4:40 | 4.41 |
| 19 | 4:55 | 4.54 |
| 20 | 5:00 | 4.43 |

*Comparative run; sand only.

As the data above demonstrate, the mixture of Br-PAC and sand quickly captured most of the mercury vapor, preventing the mercury from passing through the column. Further, this suppression of mercury vapor persisted over the entire 5 hours of the test.

### Example 3

The PAC/sand mixture and the Br-PAC/sand mixture used in the Examples above were analyzed to determine the total mercury adsorbed by the mixtures to confirm adsorption of mercury. Table 3 summarizes these results. The total mercury in the Br-PAC/sand mixture was significantly higher after 5 hours as compared to the PAC/sand mixture.

TABLE 3

| Test time (Δt) | Material | Hg in material |
|---|---|---|
| 1 hr | Sand + 1 wt % PAC | 217 ppb |
| | Sand + 1 wt % Br-PAC | 323 ppb |
| 5 hr | Sand + 1 wt % PAC | 432 ppb |
| | Sand + 1 wt % Br-PAC | 931 ppb |

### Example 4

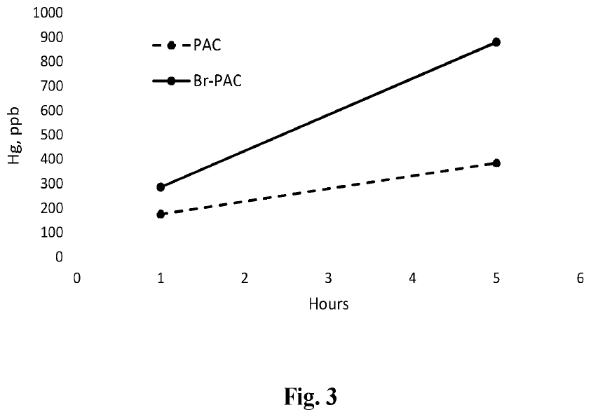

Leaching tests were performed on a PAC/sand mixture and a Br-PAC/sand mixture from the Examples above using the Synthetic Precipitation Leaching Procedure (SPLP). The total mercury remaining in each sample after performing the leaching test is considered to be nonleachable mercury. Results are summarized in Table 4, and shown graphically in FIG. 3. The data at one hour show a 163% increase of nonleachable mercury for the Br-PAC/sand mixture as compared to the PAC/sand mixture, and the data at 5 hours show a 229% increase of nonleachable mercury for the Br-PAC/sand mixture as compared to the PAC/sand mixture.

TABLE 4

| | | Hg in material |
|---|---|---|
| Test time (Δt) | Material | after leaching test |
| 1 hr | Sand + 1 wt % PAC | 175 ppb |
| | Sand + 1 wt % Br-PAC | 286 ppb |
| 5 hr | Sand + 1 wt % PAC | 384 ppb |
| | Sand + 1 wt % Br-PAC | 879 ppb |

Further embodiments of the invention include, without limitation:
A) A process for suppressing mercury vapor emission from a substance comprising vaporizable mercury, which process comprises applying a halogen-containing sorbent to said substance, wherein the halogen comprises one or more halogens selected from chlorine, bromine, and iodine, and allowing perturbation of the substance to cause mercury to volatilize, thereby suppressing emission of at least a portion of mercury vapor from the substance.
B) A process as in A) wherein the halogen-containing sorbent comprises a substrate material selected from one or more carbonaceous materials.
C) A process as in B) wherein the carbonaceous material is activated carbon.
D) A process as in A) wherein halogen-containing sorbent comprises a substrate material selected from one or more inorganic materials.
E) A process as in D) wherein the inorganic material is selected from inorganic oxides, natural zeolites, CaCO₃, and clay minerals.
F) A process as in E) wherein the inorganic material is selected from chabazite, silica, kaolinite, and bentonite.
G) A process as in A) wherein the halogen-containing sorbent is a halogen-containing activated carbon sorbent, a halogen-containing chabazite, a halogen-containing bentonite, a halogen-containing kaolinite, or a halogen-containing silica.
H) A process as in A) wherein the halogen-containing sorbent is a halogen-containing activated carbon sorbent.
I) A process as in any of A)-H) wherein the halogen is bromine and/or iodine.
J) A process as in any of A)-H) wherein the halogen is bromine.
K) A process as in any of A)-J) wherein the halogen-containing sorbent has a halogen content of:
   about 0.1 to about 30 wt % calculated as bromine and based on the total weight of the halogen-containing sorbent; or
   about 0.1 wt % to about 25 wt % calculated as bromine and based on the total weight of the halogen-containing sorbent; or
   about 0.1 wt % to about 20 wt % calculated as bromine and based on the total weight of the halogen-containing sorbent; or
   about 3 to about 8 wt % calculated as bromine and based on the total weight of the halogen-containing sorbent.
L) A process as in any of A)-K) wherein applying the halogen-containing sorbent to the substance comprises:
   (a) applying the halogen-containing sorbent to a surface of the substance; and/or
   (b) combining the halogen-containing sorbent with at least a portion of a surface of the substance; and/or
   (c) adding the halogen-containing sorbent to a reactive barrier; and/or
   (d) forming a reactive barrier containing the halogen-containing sorbent; and/or
   (e) introducing the halogen-containing sorbent subsurface to the substance.
M) A process as in L) wherein the halogen-containing sorbent is added and/or applied in the form of a slurry or suspension.
N) A process as in M) wherein the halogen-containing sorbent is about 5 wt % to about 45 wt % of the slurry or suspension.
O) A process as in L) wherein the halogen-containing sorbent is applied to the substance by spraying a suspension or slurry of the halogen-containing sorbent, by spreading a dry solid comprising the halogen-containing sorbent onto the surface of the substance. or by introducing the halogen-containing sorbent subsurface to the substance.
P) A process as in L) wherein the halogen-containing sorbent is applied to the substance by introducing the halogen-containing sorbent subsurface to the substance.
Q) A process as in any of A)-P) wherein the substance comprising vaporizable mercury is soil, waste material, mining byproducts, fly ash, or building materials.
R) A process as in any of A)-P) wherein the substance is soil, waste material, or mining byproducts.
S) A process as in any of A)-P) wherein the substance is fly ash or building materials.
T) A process as in S) wherein the substance comprising vaporizable mercury is soil.
U) A process as in any of A)-T) wherein the perturbation is heating or enclosing at least a portion of the substance.
V) A process as in U) wherein the heating is solar heating.
W) A process as in A) wherein the sorbent is halogen-containing activated carbon, wherein the halogen content is about 0.1 to about 30 wt % calculated as bromine and based on the total weight of the halogen-containing sorbent, and wherein the substance is soil, waste material, mining byproducts, fly ash, or building materials.
X) A process as in W) wherein the halogen content is about 0.1 to about 25 wt %, preferably about 0.1 wt % to about 20 wt %, more preferably about 0.5 to about 15 wt %, calculated as bromine and based on the total weight of the halogen-containing sorbent.
Y) A process as in any of A)-X) wherein the halogen is bromine and/or iodine.
Z) A process as in any of A)-X) wherein the halogen is bromine.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. A process for suppressing mercury vapor emission from a substance comprising vaporizable mercury, which process comprises
applying a halogen-containing sorbent to said substance, wherein the halogen comprises one or more halogens selected from chlorine, bromine, and iodine, and
allowing perturbation of the substance to cause mercury to volatilize,
thereby suppressing emission of at least a portion of mercury vapor from the substance.

2. A process as in claim 1 wherein the halogen-containing sorbent comprises a substrate material selected from one or more carbonaceous materials.

3. A process according to claim 2 wherein the carbonaceous material is activated carbon.

4. A process according to claim 1 wherein halogen-containing sorbent comprises a substrate material selected from one or more inorganic materials, and optionally wherein the inorganic material is selected from inorganic oxides, natural zeolites, CaCO₃, and clay minerals.

5. A process according to claim 4 wherein the inorganic material is selected from chabazite, silica, kaolinite, and bentonite.

6. A process according to claim 1 wherein the halogen-containing sorbent is a halogen-containing activated carbon sorbent.

7. A process according to claim 1 wherein the halogen is bromine and/or iodine.

8. A process according to claim 1 wherein the halogen is bromine.

9. A process according to claim 1 wherein the halogen-containing sorbent has a halogen content of about 0.1 to about 30 wt % calculated as bromine and based on the total weight of the halogen-containing sorbent.

10. A process according to claim 1 wherein applying the halogen-containing sorbent to the substance comprises:
(a) applying the halogen-containing sorbent to a surface of the substance; and/or
(b) combining the halogen-containing sorbent with at least a portion of a surface of the substance; and/or
(c) adding the halogen-containing sorbent to a reactive barrier; and/or
(d) forming a reactive barrier containing the halogen-containing sorbent; and/or
(e) introducing the halogen-containing sorbent subsurface to the substance.

11. A process according to claim 10 wherein the halogen-containing sorbent is added and/or applied in the form of a slurry or suspension.

12. A process according to claim 11 wherein the halogen-containing sorbent is about 5 wt % to about 45 wt % of the slurry or suspension.

13. A process according to claim 10 wherein the halogen-containing sorbent is applied to the substance by spraying a suspension or slurry of the halogen-containing sorbent, by spreading a dry solid comprising the halogen-containing sorbent onto the surface of the substance, or by introducing the halogen-containing sorbent subsurface to the substance.

14. A process according to claim 1 wherein the substance comprising vaporizable mercury is soil, waste material, mining byproducts, fly ash, or building materials.

15. A process according to claim 14 wherein the substance comprising vaporizable mercury is soil.

16. A process according to claim 1 wherein the perturbation is heating or enclosing at least a portion of the substance, and optionally wherein the heating is solar heating.
